(19) United States
(12) Patent Application Publication
(10) Pub. No.: US 2018/0245456 A1
(43) Pub. Date: Aug. 30, 2018

(54) DEFECT EVALUATION USING HOLOGRAPHIC IMAGING

(71) Applicant: Halliburton Energy Services, Inc., Houston, TX (US)

(72) Inventors: Reza Khalaj Amineh, Houston, TX (US); Burkay Donderici, Pittsford, NY (US); Luis Emilio San Martin, Houston, TX (US)

(73) Assignee: Halliburton Energy Services, Inc., Houston, TX (US)

(21) Appl. No.: 15/756,920

(22) PCT Filed: Nov. 12, 2015
(86) PCT No.: PCT/US2015/060276

§ 371 Date: Mar. 1, 2018

(51) Int. Cl. E21B 47/10; E21B 47/09; G01N 27/90; G01V 3/26

(52) U.S. Cl. CPC E21B 47/10; G01V 3/26; G01N 27/9033; E21B 47/0905

(57) ABSTRACT

A method, apparatus and system for defect evaluation of downhole pipes are disclosed. One such method includes transmitting an electromagnetic wave into a pipe. A first electromagnetic field response for a delta-like defect is measured from the pipe. A second electromagnetic field response for an arbitrary defect is measured from the pipe. The first and second electromagnetic field responses are calibrated and a holographic inversion is applied to the first and second calibrated electromagnetic field responses to obtain an image of the pipe along an axial and an azimuthal direction.

### BACKGROUND

Hydrocarbon production may use metal pipes, disposed in a geological formation, for bringing the hydrocarbons to the surface. Since hydrocarbon production may last for years or even decades, it is desirable to monitor the status of the metal pipes to ensure that corrosion has not degraded zonal isolation, improve production, and help protect the environment.

### BRIEF DESCRIPTION OF THE DRAWINGS

FIG. 1 is a diagram showing a system of pipes with an excitation source and sensor array in an imaging tool, according to various examples of the disclosure.

FIG. 2 is a diagram showing a decay response over time, according to various examples of the disclosure.

FIG. 3 is a flowchart of a method for defect evaluation using a multiple frequency holographic two-dimensional imaging inversion method, according to various examples of the disclosure.

FIG. 4 is a diagram showing a wireline system, according to various examples of the disclosure.

FIG. 5 is a block diagram of an example system operable to implement the activities of multiple methods, according to various examples of the disclosure.

### DETAILED DESCRIPTION

Some of the challenges noted above, as well as others, can be addressed by using a pulse eddy current technique, converting time domain data to frequency domain data and applying a multiple frequency holographic two-dimensional imaging inversion method to the data. The azimuthal sensor configuration as well as acquisition frequencies may provide a way to qualitatively image the pipes and casings using axial and azimuthal measurements.

In the interest of clarity and brevity, subsequent reference is made to pipes. However, the examples disclosed here work equally well with any metal structure such as metal casings. Thus, the term “pipe” is used to refer to pipes and casings.

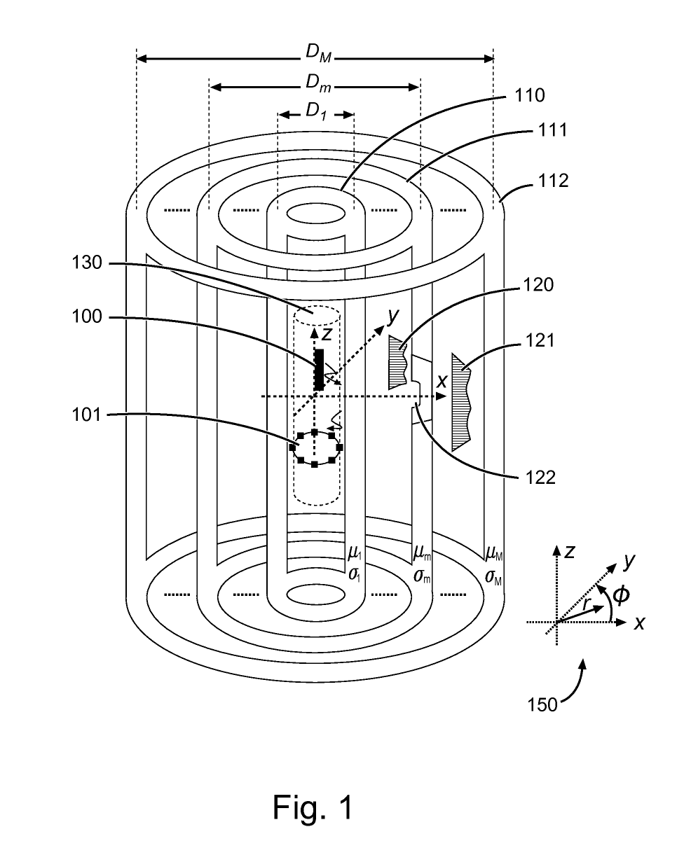

FIG. 1 is a diagram showing a system of pipes with an excitation source 100 and sensor array 101 in an imaging tool 130, according to various examples of the disclosure. The source 100 and sensor array 101 of FIG. 1 are for purposes of illustration only since other examples may use different types of sources and sensors.

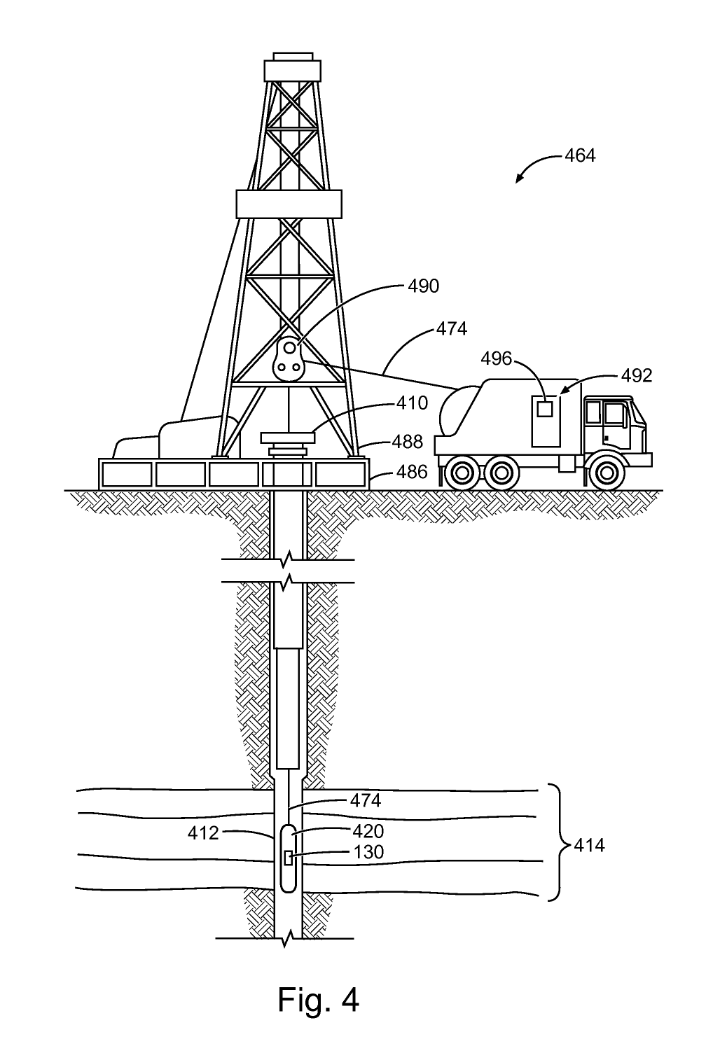

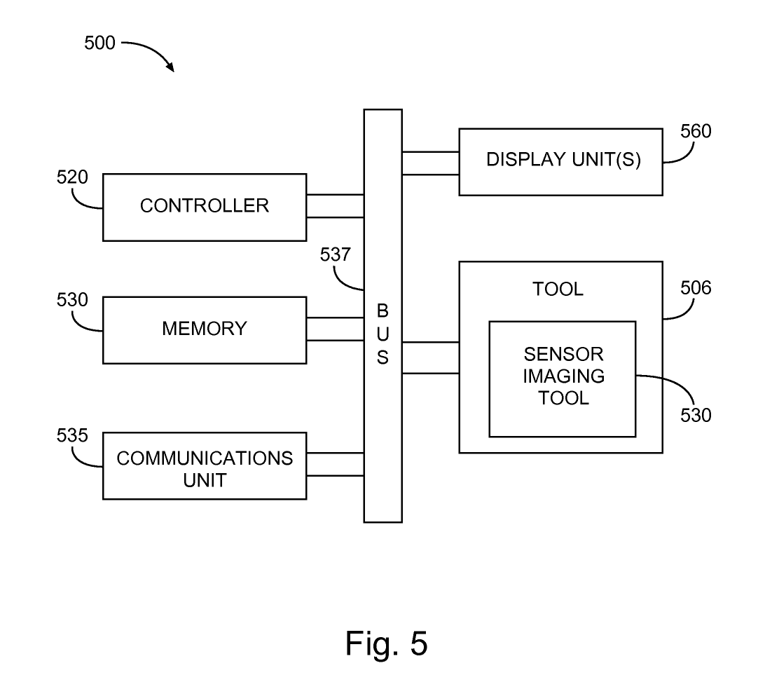

The imaging tool 130 to be used for imaging of the pipes 110-112 includes the excitation source 100 and the sensor array 101. The imaging tool 130 may be disposed in a drill string (see FIG. 4) or in a wireline tool (see FIG. 5).

In an example, the excitation source 100 may be an electromagnetic excitation source 100 that transmits an electromagnetic wave through the various pipes 110-112 and geological formation. The electromagnetic wave may have a frequency range from approximately 0.1 Hertz into the multiple kilohertz range. Lower frequencies may be used to enable the electromagnetic wave to reach pipes that are further, in a radial direction, from the excitation source 100. The higher frequencies may be used for inspection of pipes that are closer to the excitation source 100.

The sensor array 101 may be an azimuthally distributed sensor array. The azimuthal distribution of the sensors 101 provides reception of magnetic field responses from the one or more pipes 110-112 as a result of the original electromagnetic wave generated by the source 100. A measurable radial distance from the source 100 may be increased by increasing the separation distance between the source 100 and the sensor array 101.

The imaging tool 130 may include or be coupled to control circuitry, such as the system of FIG. 5. The control circuitry may be included in the imaging tool housing or on the surface, as shown in the systems of FIGS. 4 and 5. The control circuitry may control the transmission of sinusoidal signals to the excitation source, as well as analyzing and processing received signals from the sensor array 101.

One or more pipes 110-112 may include various defects 120-122. For example, one defect 122 may include a small region of metal loss (i.e., delta-like defect) while other defects 120-121 may include larger metal loss and/or permeability problems (i.e., corrosion defect). The one or more pipes 110-112 are shown in a concentric orientation for purposes of illustration. The examples disclosed herein operate equally well on pipes having other orientations.

For purposes of the following described holographic two-dimensional imaging inversion method, there are assumed to be a total of M pipes 110-112 where each pipe 110-112 has a diameter D. Thus, the inner-most pipe 110, in which the imaging tool 130 is lowered, has a diameter of D₁. The outer-most pipe 112 has a diameter of D_{M}. The m^{th} pipe 111 in between these two pipes 110, 112 has a diameter of Dₘ, where m can be any number in the range of 1 to M, (excluding M).

Also for purposes of the holographic two-dimensional imaging inversion method, each pipe 110-112 is assumed to have a magnetic permeability of μ and an electrical conductivity of σ. Thus, μₘ represents the magnetic permeability of the m^{th} pipe and σₘ represents the electrical conductivity of the m^{th} pipe.

An axes orientation diagram 150 is shown for purposes of determining an orientation of the metal defects 120-122 with respect to the source 100 and sensor array 101. The z-axis is shown to be length-wise (i.e., axially) along the pipes 110-112. Each metal defect 120-122 is assumed to have an orientation angle ϕ with respect to a reference axis (e.g., x-axis) and a distance r with respect to a centerline of the imaging tool 130. As used subsequently, the m^{th} pipe is shown having a delta-like defect and an arbitrary defect 120 on the m^{th} casing.

In operation, the excitation source 100 transmits one or more primary electromagnetic waves as a result of signals input to the source 100. The electromagnetic waves are transmitted radially outward through the pipes 110-112. When an electromagnetic wave hits one or more of the pipes 110-112, eddy currents are generated in each pipe that receives the electromagnetic wave. The eddy currents produce a secondary magnetic field that is picked up, with the primary magnetic field, by the sensor array 101 over a particular time period. The defect(s) 120-122 in the one or more pipes 110-112 has an effect on the secondary magnetic field from that particular pipe. Since one sensor of the sensor array 101 is closer to the defect(s) than the other sensors, that particular sensor may receive a different signal than the other sensors of the array 101.

Measurement of the magnetic field response (e.g., magnetic field data) by the sensor array 101 may be accomplished in either the time domain or the frequency domain. The following method assumes that the measured data is in the frequency domain. Thus, if time domain data is measured, it may be transformed to frequency domain data by a Fourier transform process.

Measurements in the frequency domain may collect data at multiple frequencies within a predetermined range of frequencies. The number of frequencies and the predetermined range of frequencies over which data are collected is determined by the number of pipe measurements (e.g., amount of information desired). Each pipe is associated with a different response at a respective frequency. Thus, the more pipe measurements to be accomplished, the greater the number of frequencies used.

Once frequency domain data is collected by the magnetic field measurements with the sensor array 101 (or time domain data converted to frequency domain data), the data may be analyzed by the subsequently described multiple frequency holographic two-dimensional imaging inversion method to produce two-dimensional images of the one or more pipes.

In order to apply the multiple frequency holographic two-dimensional imaging inversion method, it is assumed, based on the Born approximation, that the measurement system is linear. Once the measured response to a small defect is obtained in a linear measurement system, the measured response for any other investigated arbitrary defect may be approximately determined. A relatively small (but measurable) defect 122 on m^{th} casing at z=0 and ϕ=0, as shown in FIG. 1, can be approximated with a Dirac delta function at a radial distance of Dₘ/2 (where Dₘ is the diameter of the m^{th} casing). Such a small defect may be referred to as a delta-like defect. In mathematics, the Dirac delta function is a distribution on the real number line that is zero everywhere except at zero, with an integral of one over the entire real line. Here, the delta-like defect can have arbitrary shape but it should be as small as possible. Its length along the axial direction can be in the order of or smaller than the resolution of the system but its response should be still measurable with good accuracy. The function representing the shape of the delta-like defect may be represented by δ(z,ϕ,Dₘ/2), where z is the position along the axial direction, ϕ is the angle along the azimuthal direction, and Dₘ/2 is the radial position of the small defect 122. The response of the delta-like defect measured by a generic sensor at an angle ϕ over the z-axis at a single frequency ω may be represented by h(z,ϕ,Dₘ/2,ω).

The response h(z,ϕ,Dₘ/2,ω) is calibrated such that it includes the response due to the delta-like defect only and not due to the tubing/casings. The calibration is performed by measuring two responses. A first response is determined with the presence of the defect and a second response is determined without the defect. The two responses are then subtracted to generate the calibrated response. The calibrated response r due to any arbitrary defect function x(z,ϕ,Dₘ/2) in the m^{th} casing, as shown in FIG. 1, can be written in terms of the calibrated delta-like defect response h(z,ϕ,Dₘ/2, ω) as:

r(z,ϕ,Dₘ/2,ω)≈x(z,ϕ,Dₘ/2)**_{2π}h(z,ϕ,Dₘ/2,ω) (1)

where * denotes a convolution operation along the z direction, *_{2π} denotes a 2π-periodic convolution along the ϕ direction (since all the functions are periodic along this direction), and ω denotes the operation frequency.

By taking the Fourier transform (FT) of both sides with respect to the z variable and computing the Fourier series coefficients (FSC) of Equation (1) with respect to the ϕ variable, Equation (2) is obtained:

R(k_{z},n_{ϕ},Dₘ/2,ω)≈X(k_{z},n_{ϕ},Dₘ/2)H(k_{z},n_{ϕ},Dₘ/2,ω) (2)

where R, X, and Hare obtained from the r, x, and h functions, respectively, when taking the FT with respect to z variable and computing FSC with respect to the ϕ variable, k_{z} is the Fourier variable corresponding to z variable, and n_{ϕ} is the index for the FSCs. From Equation (2), it may be observed that if the calibrated response h is obtained due to a delta-like defect in the m^{th} casing beforehand, and if a response r due to an arbitrary defect function x in the same casing is measured, the defect function may be estimated.

As discussed previously, magnetic field data may be acquired over multiple frequencies of the frequency domain or in the time domain. If calibrated responses have been collected at N frequencies (for both delta-like defect 122 and arbitrary defect regions 120 on m^{th} casing), Equation (2) may lead to the following system of equations:

$$[ \begin{matrix}R ( {k}_{z} , {n}_{φ} , {D}_{m} / 2 , {ω}_{1} ) \\ ⋮ \\ R ( {k}_{z} , {n}_{φ} , {D}_{m} / 2 , {ω}_{N} )\end{matrix} ] \approx [ \begin{matrix}H ( {k}_{z} , {n}_{φ} , {D}_{m} / 2 , {ω}_{1} ) \\ ⋮ \\ H ( {k}_{z} , {n}_{φ} , {D}_{m} / 2 , {ω}_{N} )\end{matrix} ] X ( {k}_{z} , {n}_{φ} , {D}_{m} / 2 ) \qquad ( 3 )$$

This system of equations can be solved for X(k_{z},n_{ϕ},Dₘ/2). Such separate systems of equations are solved for all k_{z} and n_{ϕ} values. Once they are solved, the reconstruction of the tested defect x(z,n_{ϕ},Dₘ/2) is obtained by taking the inverse FT of X(k_{z},n_{ϕ},Dₘ/2) with respect to the k_{z} variable and using FSC with respect to the ϕ variable.

If time domain data acquisition has been adopted (e.g., in pulsed eddy current), the FT of the collected data may be implemented to obtain the frequency-domain data. Then, by proper sampling of the data in the frequency domain, the system of equations in Equation (3) may be constructed. The use of multiple frequency data may improve the robustness of the data to noise.

Equations 1-3 above may be used in determining delta-like defects 122 and corrosion 120 on one pipe (e.g., m^{th} pipe). The holographic imaging technique may also be used in evaluating corrosion 120 and delta-like defects 122 on multiple pipes. In such a scenario, the calibrated response may be approximated using a superposition principle. In other words, the calibrated response is obtained from the sum of the individual responses due to the corrosion and delta-like defects on each pipe. Thus, assuming that the defects for pipes 1 to M are being imaged, Equation (2) may be written as:

R(k_{z},n_{ϕ},ω)≈X(k_{z},n_{ϕ},Dₘ/2)H(k_{z},n_{ϕ},Dₘ/2,ω)+ . . . +X(k_{z},n_{ϕ},Dₘ/2)H(k_{z},n_{ϕ},Dₘ/2,ω) (4)

Writing Equation (4) at N frequencies leads to the system of equations (5):

$$[ \begin{matrix}R ( {k}_{z} , {n}_{φ} , {ω}_{1} ) \\ ⋮ \\ R ( {k}_{z} , {n}_{φ} , {ω}_{N} )\end{matrix} ] \approx [ \begin{matrix}H ( {k}_{z} , {n}_{φ} , {D}_{1} / 2 , {ω}_{1} ) & … & H ( {k}_{z} , {n}_{φ} , {D}_{M} / 2 , {ω}_{1} ) \\ ⋮ & ⋱ & ⋮ \\ H ( {k}_{z} , {n}_{φ} , {D}_{1} / 2 , {ω}_{N} ) & & H ( {k}_{z} , {n}_{φ} , {D}_{M} / 2 , {ω}_{N} )\end{matrix} ] [ \begin{matrix}X ( {k}_{z} , {n}_{φ} , {D}_{1} / 2 ) \\ ⋮ \\ X ( {k}_{z} , {n}_{φ} , {D}_{M} / 2 )\end{matrix} ] \qquad ( 5 )$$

The system of equations (5) can be solved for X(k_{z},n_{ϕ},Dₘ/2), m=1, . . . , M. The separate systems of equations are solved for all k_{z} and n_{ϕ} values. Once they are solved, the reconstruction of the images of the casings x(z,n_{ϕ},Dₘ/2), m=1, . . . , M are obtained by taking the inverse FT of X(k_{z},n_{ϕ}, Dₘ/2), m=1, . . . M with respect to the k_{z} variable and using FSCs with respect to the ϕ variable.

Using the measurements from multiple magnetic field sensors of the sensor array 101, data with different coil or dipole orientations may be acquired in order to obtain azimuthally sensitive signals. In general, tri-axial coils may be used. Assuming hₗ(z,ϕ,Dₘ/2, ω) (l=1, . . . , L) denotes the calibrated delta-like defect responses measured by the sensors oriented toward the l^{th}direction (when tri-axial coils are employed L=3) and for the delta-like defect on the m^{th} casing, Equation (4) can be written for all the sensors as:

$$\{ \begin{matrix}\begin{matrix}{R}_{1} ( {k}_{z} , {n}_{φ} , ω ) \approx X ( {k}_{z} , {n}_{φ} , {D}_{1} / 2 ) {H}_{1} ( {k}_{z} , {n}_{φ} , {D}_{1} / 2 , ω ) + … + \\ X ( {k}_{z} , {n}_{φ} , {D}_{M} / 2 ) {H}_{1} ( {k}_{z} , {n}_{φ} , {D}_{M} / 2 , ω )\end{matrix} \\ ⋮ \\ \begin{matrix}{R}_{L} ( {k}_{z} , {n}_{φ} , ω ) \approx X ( {k}_{z} , {n}_{φ} , {D}_{1} / 2 ) {H}_{L} ( {k}_{z} , {n}_{φ} , {D}_{1} / 2 , ω ) + … + \\ X ( {k}_{z} , {n}_{φ} , {D}_{M} / 2 ) {H}_{L} ( {k}_{z} , {n}_{φ} , {D}_{M} / 2 , ω )\end{matrix}\end{matrix} \qquad ( 6 )$$

where Hₗ(k_{z},n_{ϕ},Dₘ/2,ω) is obtained from hₗ(z,ϕ,Dₘ/2,ω), when taking the FT with respect to the z variable and computing the FSC with respect to the ϕ variable. Since the unknowns X(k_{z},n_{ϕ}, Dₘ/2), m=1, . . . , M are common for all the equations above, a single system of equations may be derived as:

$$[ \begin{matrix}{R}_{1} ( {k}_{z} , {n}_{φ} , {ω}_{1} ) \\ ⋮ \\ {R}_{1} ( {k}_{z} , {n}_{φ} , {ω}_{N} ) \\ ⋮ \\ {R}_{L} ( {k}_{z} , {n}_{φ} , {ω}_{1} ) \\ ⋮ \\ {R}_{L} ( {k}_{z} , {n}_{φ} , {ω}_{N} )\end{matrix} ] \approx [ \begin{matrix}{H}_{1} ( {k}_{z} , {n}_{φ} , {D}_{1} / 2 , {ω}_{1} ) & … & {H}_{1} ( {k}_{z} , {n}_{φ} , {D}_{M} / 2 , {ω}_{1} ) \\ ⋮ & ⋱ & ⋮ \\ {H}_{1} ( {k}_{z} , {n}_{φ} , {D}_{1} / 2 , {ω}_{N} ) & … & {H}_{1} ( {k}_{z} , {n}_{φ} , {D}_{M} / 2 , {ω}_{N} ) \\ ⋮ & & \\ {H}_{L} ( {k}_{z} , {n}_{φ} , {D}_{1} / 2 , {ω}_{1} ) & … & {H}_{L} ( {k}_{z} , {n}_{φ} , {D}_{M} / 2 , {ω}_{1} ) \\ ⋮ & ⋱ & ⋮ \\ {H}_{L} ( {k}_{z} , {n}_{φ} , {D}_{1} / 2 , {ω}_{N} ) & … & {H}_{L} ( {k}_{z} , {n}_{φ} , {D}_{M} / 2 , {ω}_{N} )\end{matrix} ] [ \begin{matrix}X ( {k}_{z} , {n}_{φ} , {D}_{1} / 2 ) \\ ⋮ \\ X ( {k}_{z} , {n}_{φ} , {D}_{M} / 2 )\end{matrix} ] \qquad ( 7 )$$

This system of equations can be solved for X(k_{z},n_{ϕ},Dₘ/2), m=1, . . . M. Such separate systems of equations are solved for all k_{z} and n_{ϕ} values. Once they are solved, the reconstruction of the images of the casings x(z,n_{ϕ},Dₘ/2), m=1, . . . , M are obtained by taking the inverse FT of X(k_{z},n_{ϕ}, Dₘ/2), m=1, . . . , M with respect to the k_{z} variable and using FSCs with respect to the ϕ variable.

The sensors of the sensor array 101 may have various dimensions such that the smaller sensors measure the responses due to the inner most pipes. This may simplify the imaging process for the inner-most pipes and provide a more precise estimate for corrosion for those pipes. These estimations may then be used to image the outer-most casings with improved accuracy.

In the disclosed holographic imaging inversion approach presented above, it is assumed that the calibrated delta-like defect response is known a priori. This data may be determined beforehand by measuring relatively small delta-like defects for various numbers of pipes with variable permeability, thicknesses, and outer diameters. In an example, the resulting data may be stored in a library of delta-like defect responses and retrieved by the control circuitry during analysis and processing of received electromagnetic waves. In another example, this information may be obtained from a forward model through simulations.

In order to image the defected regions, the permeability of the pipes is initially estimated. This enables the use of the previously determined delta-like defect responses in the library that correspond to those permeability values.

When acquiring data in the frequency domain at multiple frequencies, the data at higher and lower frequencies may be employed to estimate the permeability values for inner most and outer most pipes, respectively. When acquiring data in the time domain, the decay responses over a period of time may be processed. The permeability values for outer pipes affect the response at longer decay times.

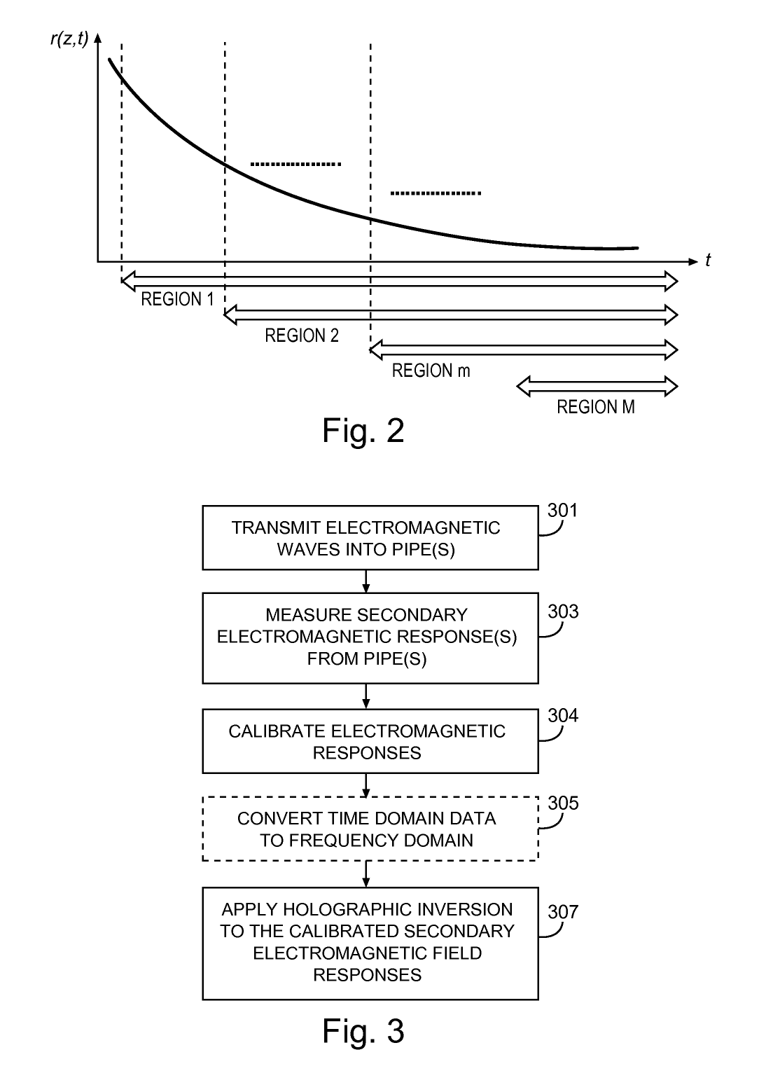

FIG. 2 is a diagram showing a decay response over time, according to various examples of the disclosure. This diagram shows time along the x-axis and the response r due to arbitrary metal loss is shown along the y-axis.

The permeability of the inner most pipes may first be estimated from the data acquired by relatively smaller sensor (e.g., shorter sensors) and the permeability of the outer most pipes may be estimated from the data acquired by relatively larger sensor (e.g., longer sensors). It is also possible to estimate the permeability values of all the pipes from the data acquired from the relatively larger sensor. This can be performed by dividing the decay response of the sensor into M regions, as shown in FIG. 2, such that the effect of the m^{th} pipe is observed from the beginning of the m^{th} region. Then, by processing the values of the decay response at these sub-regions, the permeability of the pipes may be estimated.

In a logging process (e.g., wireline) it may not be cost-effective to apply the holographic two-dimensional imaging method for the whole log at one time, due to numerical costs and stability issues. However, at each depth where measurements are taken, a borehole section length (i.e., window) may be defined that is centered at that depth and an inversion problem may be solved. A separate depth range may be defined for each inversion problem solution so that the holographic inversion is applied for the electromagnetic field responses received for each borehole section length. After the results at each depth are computed, the results may be combined together to obtain a single and two-dimensional image along the depth and azimuthal directions of the wellbore. An example of one such wireline system is illustrated subsequently with reference to FIG. 4.

FIG. 3 is a flowchart of a method for defect evaluation using a multiple frequency holographic two-dimensional imaging inversion method, according to various examples of the disclosure. Block 301 includes transmitting an electromagnetic wave into a pipe. Another example may operate to transmit a plurality of electromagnetic waves into a plurality of pipes.

In an example, the plurality of electromagnetic waves may be transmitted by feeding the excitation source 100 of FIG. 1 with sinusoidal signals, each having a different frequency. Thus, each transmitted electromagnetic wave will have an associated respective frequency. The plurality of electromagnetic waves may then be transmitted into the plurality of pipes. The plurality of electromagnetic waves may be transmitted at the multiple frequencies substantially simultaneously or each different electromagnetic wave frequency may be transmitted sequentially.

Block 303 includes measuring or calculating the electromagnetic field response (e.g., in a linear manner) from the pipe or plurality of pipes, depending on the example. For example, a first electromagnetic field response may be measured or calculated from the pipe for a delta-like defect and a second electromagnetic field response may be measured from the pipe for an arbitrary defect. Block 304 includes calibrating the first and second electromagnetic field responses. Block 307 includes applying a holographic inversion to the calibrated electromagnetic field response.

The calibration may include measuring or calculating a third electromagnetic field response from the pipe or pipes without a defect (e.g., without metal loss) and corresponding to the first electromagnetic field response, measuring or calculating a fourth electromagnetic field response from the pipe or pipes without a defect and corresponding to the second electromagnetic field response, then subtracting the third electromagnetic field response from the first electromagnetic field response to generate a first calibrated electromagnetic field response and subtracting the fourth electromagnetic field response from the second electromagnetic field response to generate a second calibrated electromagnetic field response.

The holographic inversion comprises determining a spatial Fourier transform of the first and second calibrated electromagnetic field responses along the axial direction and the azimuthal direction, determining a plurality of Fourier series coefficients for the calibrated electromagnetic responses for a delta-like defect and the arbitrary defect along the azimuthal direction, solving the relevant systems of equations, using inverse Fourier transform of the defect function along the axial direction and Fourier series coefficients of the defect function along the azimuthal direction to compute a two-dimensional image of the pipe.

In optional block 305, if the magnetic field response comprises time domain data, the method may include first converting the time domain data to frequency domain data prior to applying the holographic inversion.

FIG. 4 is a diagram showing a wireline system 464, according to various examples of the disclosure. The system 464 may comprise at least one wireline logging tool body 420, as part of a wireline logging operation in a cased borehole 412, including the sensor imaging tool 130 as described previously.

A drilling platform 486 equipped with a derrick 488 that supports a hoist 490 can be seen. Drilling oil and gas wells is commonly carried out using a string of drill pipes connected together so as to form a drillstring that is lowered through a rotary table 410 into the cased borehole 412. Here it is assumed that the drillstring has been temporarily removed from the cased borehole 412 to allow the wireline logging tool body 420, such as a probe or sonde with the sensor imaging tool 130, to be lowered by wireline or logging cable 474 (e.g., slickline cable) into the cased borehole 412. Typically, the wireline logging tool body 420 is lowered to the bottom of the region of interest and subsequently pulled upward at a substantially constant speed.

During the upward trip, at a series of depths, the sensor imaging tool 130 may be used to image the pipes of the cased borehole 412. The resulting data may be communicated to a surface logging facility (e.g., workstation 492) for processing, analysis, and/or storage. The workstation 492 may have a controller 496 that is able to execute any methods disclosed herein.

FIG. 5 is a block diagram of an example system 500 operable to implement the activities of multiple methods, according to various examples of the disclosure. The system 500 may include a tool housing 506 having the sensor imaging tool 130 disposed therein. The system 500 may be implemented as shown in FIG. 4 with reference to the workstation 492 and controller 496.

The system 500 may include a controller 520, a memory 530, and a communications unit 535. The memory 530 may be structured to include a database. The controller 520, the memory 530, and the communications unit 535 may be arranged to operate as a processing unit to control operation of the sensor imaging tool 130 and execute any methods disclosed herein in order to determine the condition of borehole pipes.

The communications unit 535 may include communications capability for communicating from downhole to the surface or from the surface to downhole. Such communications capability can include a telemetry system such as mud pulse telemetry. In another example, the communications unit 535 may use combinations of wired communication technologies and wireless technologies.

The system 500 may also include a bus 537 that provides electrical conductivity among the components of the system 500. The bus 537 can include an address bus, a data bus, and a control bus, each independently configured or in an integrated format. The bus 537 may be realized using a number of different communication mediums that allows for the distribution of components of the system 500. The bus 537 may include a network. Use of the bus 537 may be regulated by the controller 520.

The system 500 may include display unit(s) 560 as a distributed component on the surface of a wellbore, which may be used with instructions stored in the memory 530 to implement a user interface to monitor the operation of the tool 506 or components distributed within the system 500. The user interface may be used to input parameter values for thresholds such that the system 500 can operate autonomously substantially without user intervention in a variety of applications. The user interface may also provide for manual override and change of control of the system 500 to a user. Such a user interface may be operated in conjunction with the communications unit 535 and the bus 537.

These implementations can include a machine-readable storage device having machine-executable instructions, such as a computer-readable storage device having computer-executable instructions. Further, a computer-readable storage device may be a physical device that stores data represented by a physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices.

The holographic two-dimensional imaging method utilizes data acquisition at multiple frequencies to reconstruct 2D images of the casing. A quantity and configuration of sensors of the sensor array, as well as acquisition frequencies, provide a way to qualitatively image the pipes using measurements along the axial direction. The capability of resolving the defects on separate casings and also imaging the defects on each casing with better resolution may improve remedial actions for the pipes. Many examples may thus be realized. A few examples will now be described.

Example 1 is a method comprising: transmitting an electromagnetic wave into a pipe; obtaining a first electromagnetic field response from the pipe; measuring a second electromagnetic field response from the pipe; calibrating the first and second electromagnetic field responses; calculating a transform of the first and second calibrated electromagnetic field responses wherein the transform is applied in axial and azimuthal directions; and processing the transform to obtain an image of the pipe along the axial and the azimuthal directions.

In Example 2, the subject matter of Example 1 can further include wherein calibrating the first and second electromagnetic field responses comprises: measuring or calculating a third electromagnetic field response from the pipe without a defect corresponding to the first electromagnetic field response; measuring or calculating a fourth electromagnetic field response from the pipe without a defect corresponding to the second electromagnetic field response; subtracting the third electromagnetic field response from the first electromagnetic field response to generate a first calibrated electromagnetic field response; and subtracting the fourth electromagnetic field response from the second electromagnetic field response to generate a second calibrated electromagnetic field response.

In Example 3, the subject matter of Examples 1-2 can further include wherein the first and second electromagnetic field responses or the first and second calibrated electromagnetic field responses comprise frequency domain data.

In Example 4, the subject matter of Examples 1-3 can further include wherein the first and second electromagnetic field responses or the first and the second calibrated electromagnetic field responses comprise time domain data and the method further comprises converting the time domain data to frequency domain data prior to applying a holographic inversion comprising a spatial Fourier transform of the first and second calibrated electromagnetic field responses.

In Example 5, the subject matter of Examples 1-4 can further include wherein transmitting the electromagnetic wave comprises: feeding an excitation source with sinusoidal signals having different frequencies to generate a plurality of electromagnetic waves, each having a respective different frequency; and transmitting the plurality of electromagnetic waves into a plurality of pipes.

In Example 6, the subject matter of Examples 1-5 can further include wherein the plurality of electromagnetic waves are transmitted sequentially or substantially simultaneously.

In Example 7, the subject matter of Examples 1-6 can further include wherein transmitting the plurality of electromagnetic waves into the plurality of pipes comprises transmitting the plurality of electromagnetic waves into a plurality of concentric pipes.

In Example 8, the subject matter of Examples 1-7 can further include wherein calculating the spatial Fourier transform and processing the Fourier transform are part of a multiple frequency holographic inversion and measuring the first and second electromagnetic field responses comprises measuring frequency domain data over a plurality of frequencies.

In Example 9, the subject matter of Examples 1-8 can further include wherein the holographic inversion further comprises: determining a plurality of Fourier series coefficients for the first and second calibrated electromagnetic field responses along the azimuthal direction; solving a system of equations to find a Fourier transform of a defect function along the axial direction and a Fourier series coefficients of the defect function along the azimuthal direction; determining a two-dimensional image of the pipe based on an inverse Fourier transform of the defect function along the axial direction and the Fourier series coefficients of the defect function along the azimuthal direction.

In Example 10, the subject matter of Examples 1-9 can further include: measuring the first and second electromagnetic field responses at different frequencies; and calibrating each of the electromagnetic field responses at its respective frequency.

Example 11 is an apparatus comprising: an excitation source to emit a plurality of electromagnetic waves into at least one pipe; a sensor array to receive a plurality of electromagnetic responses, each at a received frequency, from the at least one pipe; and control circuitry coupled to the excitation source and the sensor array, the control circuitry to control transmission of the plurality of electromagnetic waves, measure the electromagnetic field responses, and perform a holographic inversion on the electromagnetic field responses.

In Example 12, the subject matter of Example 11 can further include wherein each transmitted electromagnetic wave comprises a different respective frequency and the control circuitry is further to control sequential transmission of each electromagnetic wave.

In Example 13, the subject matter of Examples 11-12 can further include wherein each transmitted electromagnetic wave comprises a different respective frequency and the control circuitry is further to control substantial simultaneous transmission of the plurality of electromagnetic waves.

In Example 14, the subject matter of Examples 11-13 can further include wherein the control circuitry is further to determine a calibrated response by acquiring the individual responses over the received frequencies, each individual response due to a respective sensor.

Example 15 is a system comprising: an imaging tool comprising: an excitation source to emit a plurality of electromagnetic waves into at least one pipe; and an azimuthally distributed sensor array to receive a plurality of electromagnetic field responses from the at least one pipe at a respective received frequency; and control circuitry coupled to the imaging tool, the control circuitry to calibrate the plurality of electromagnetic field responses and apply a holographic inversion to the plurality of calibrated electromagnetic field responses to obtain a two-dimensional image of the at least one pipe.

In Example 16, the subject matter of Example 15 can further include wherein the imaging tool is disposed in a wireline tool.

In Example 17, the subject matter of Examples 15-16 can further include wherein the control circuitry is further to convert the plurality of electromagnetic field responses from time domain data to frequency domain data.

In Example 18, the subject matter of Examples 15-17 can further include wherein the control circuitry is further to define a plurality of borehole section lengths centered at a depth in the borehole, the control circuitry further to apply the holographic inversion on the calibrated electromagnetic field responses received for each borehole section length to generate the two-dimensional image for each borehole section length.

In Example 19, the subject matter of Examples 15-18 can further include wherein the control circuitry is further to combine the two-dimensional images for the plurality of borehole section lengths to generate a two-dimensional image of the at least one pipe.

In Example 20, the subject matter of Examples 15-19 can further include wherein the control circuitry is further to determine a permeability value for the at least one pipe.

Although specific examples have been illustrated and described herein, it will be appreciated by those of ordinary skill in the art that any arrangement that is calculated to achieve the same purpose may be substituted for the specific examples shown. Various examples use permutations and/or combinations of examples described herein. It is to be understood that the above description is intended to be illustrative, and not restrictive, and that the phraseology or terminology employed herein is for the purpose of description. Combinations of the above examples and other examples will be apparent to those of skill in the art upon studying the above description.

What is claimed is:

1. A method comprising:
transmitting an electromagnetic wave into a pipe;
obtaining a first electromagnetic field response from the pipe;
measuring a second electromagnetic field response from the pipe;
calibrating the first and second electromagnetic field responses;
calculating a transform of the first and second calibrated electromagnetic field responses wherein the transform is applied in axial and azimuthal directions; and
processing the transform to obtain an image of the pipe along the axial and the azimuthal directions.

2. The method of claim 1, wherein calibrating the first and second electromagnetic field responses comprises:
measuring or calculating a third electromagnetic field response from the pipe without a defect corresponding to the first electromagnetic field response;
measuring or calculating a fourth electromagnetic field response from the pipe without a defect corresponding to the second electromagnetic field response;
subtracting the third electromagnetic field response from the first electromagnetic field response to generate a first calibrated electromagnetic field response; and
subtracting the fourth electromagnetic field response from the second electromagnetic field response to generate a second calibrated electromagnetic field response.

3. The method of claim 1, wherein the first and second electromagnetic field responses or the first and second calibrated electromagnetic field responses comprise frequency domain data.

4. The method of claim 1, wherein the first and second electromagnetic field responses or the first and the second calibrated electromagnetic field responses comprise time domain data and the method further comprises converting the time domain data to frequency domain data prior to applying a holographic inversion comprising a spatial Fourier transform of the first and second calibrated electromagnetic field responses.

5. The method of claim 1, wherein transmitting the electromagnetic wave comprises:
feeding an excitation source with sinusoidal signals having different frequencies to generate a plurality of electromagnetic waves, each having a respective different frequency; and
transmitting the plurality of electromagnetic waves into a plurality of pipes.

6. The method of claim 5, wherein the plurality of electromagnetic waves are transmitted sequentially or substantially simultaneously.

7. The method of claim 5, wherein transmitting the plurality of electromagnetic waves into the plurality of pipes comprises transmitting the plurality of electromagnetic waves into a plurality of concentric pipes.

8. The method of claim 1, wherein calculating the spatial Fourier transform and processing the Fourier transform are part of a multiple frequency holographic inversion and measuring the first and second electromagnetic field responses comprises measuring frequency domain data over a plurality of frequencies.

9. The method of claim 1, wherein the holographic inversion further comprises:
determining a plurality of Fourier series coefficients for the first and second calibrated electromagnetic field responses along the azimuthal direction;
solving a system of equations to find a Fourier transform of a defect function along the axial direction and a Fourier series coefficients of the defect function along the azimuthal direction;
determining a two-dimensional image of the pipe based on an inverse Fourier transform of the defect function along the axial direction and the Fourier series coefficients of the defect function along the azimuthal direction.

10. The method of claim 1, further comprising:
measuring the first and second electromagnetic field responses at different frequencies; and
calibrating each of the electromagnetic field responses at its respective frequency.

11. An apparatus comprising:
an excitation source to emit a plurality of electromagnetic waves into at least one pipe;
a sensor array to receive a plurality of electromagnetic responses, each at a received frequency, from the at least one pipe; and
control circuitry coupled to the excitation source and the sensor array, the control circuitry to control transmission of the plurality of electromagnetic waves, measure the electromagnetic field responses, and perform a holographic inversion on the electromagnetic field responses.

12. The apparatus of claim 11, wherein each transmitted electromagnetic wave comprises a different respective frequency and the control circuitry is further to control sequential transmission of each electromagnetic wave.

13. The apparatus of claim 11, wherein each transmitted electromagnetic wave comprises a different respective frequency and the control circuitry is further to control substantial simultaneous transmission of the plurality of electromagnetic waves.

14. The apparatus of claim 11, wherein the control circuitry is further to determine a calibrated response by acquiring the individual responses over the received frequencies, each individual response due to a respective sensor.

15. A system comprising:
an imaging tool comprising:
an excitation source to emit a plurality of electromagnetic waves into at least one pipe; and
an azimuthally distributed sensor array to receive a plurality of electromagnetic field responses from the at least one pipe at a respective received frequency; and
control circuitry coupled to the imaging tool, the control circuitry to calibrate the plurality of electromagnetic field responses and apply a holographic inversion to the plurality of calibrated electromagnetic field responses to obtain a two-dimensional image of the at least one pipe.

16. The system of claim 15, wherein the imaging tool is disposed in a wireline tool.

17. The system of claim 15, wherein the control circuitry is further to convert the plurality of electromagnetic field responses from time domain data to frequency domain data.

18. The system of claim 15, wherein the control circuitry is further to define a plurality of borehole section lengths centered at a depth in the borehole, the control circuitry further to apply the holographic inversion on the calibrated electromagnetic field responses received for each borehole section length to generate the two-dimensional image for each borehole section length.

19. The system of claim 18, wherein the control circuitry is further to combine the two-dimensional images for the plurality of borehole section lengths to generate a two-dimensional image of the at least one pipe.

20. The system of claim 15, wherein the control circuitry is further to determine a permeability value for the at least one pipe.
